(19) United States
(12) Patent Application Publication
(10) Pub. No.: US 2025/0276314 A1
(43) Pub. Date: Sep. 4, 2025

(54) MICROFLUIDIC ASSEMBLY

(71) Applicant: miDiagnostics NV, Heverlee (BE)

(72) Inventors: David MIKAELIAN, Heverlee (BE); Thierry TOLLENBOOM, Heverlee (BE)

(73) Assignee: miDiagnostics NV, Heverlee (BE)

(21) Appl. No.: 18/858,039

(22) PCT Filed: Apr. 19, 2023
(86) PCT No.: PCT/EP2023/060127

§ 371 Date: Oct. 18, 2024

(30) Foreign Application Priority Data
Apr. 20, 2022 (EP) 22169055.5

(51) Int. Cl. B01L 3/00

(52) U.S. Cl. CPC B01L 3/502707; B01L 2200/025; B01L 2200/0684; B01L 2200/0689; B01L 2300/04; B01L 2300/0883; B01L 2300/0887; B01L 2300/16

(57) ABSTRACT

The field of the invention generally relates to biological sample analysis devices that use very small volumes of fluids. In particular, a microfluidic assembly is disclosed herein for performing an assay on a biological sample on a patterned microfluidic chip, wherein the assembly is designed for making the handling of small liquid volumes easy for users.

### FIELD OF THE INVENTION

The field of the invention generally relates to biological sample analysis devices that use very small volumes of fluids. In particular, a microfluidic assembly is disclosed herein for performing an assay on a biological sample on a patterned microfluidic chip, wherein the assembly is designed for making the handling of small liquid volumes easy for users.

### BACKGROUND OF THE INVENTION

Microfluidics in general deals with behaviour of fluids through micro-channels, and with the technology of manufacturing miniaturized devices containing such channels and chambers in which tiny volumes of fluids can flow and be retained. Fluids behave very differently on the micrometric scale from what we are used to in daily life based on our observations of more “conventional” volumes. These unique behaviours are heavily relied upon in molecular diagnostics and many other bio-analytical approaches where microfluidics-based technologies have become a cornerstone for automation and speeding-up of practically all types of molecular assays.

The main advantages of fully automated microfluidic systems are the cost and time savings which these systems achieve through better use of limited staff resources and by allowing quicker detection times, which two considerations are of critical importance in clinical settings. The superior detection speeds primarily stem from the ability of microfluidic systems to use extremely low, i.e. nanoliter- and microliter-scale, reaction volumes of liquids, as well as the fact of the relatively straightforward automatability of these systems in general.

For these and other reasons, microfluidics-based systems are broadly employed in life science and medical fields as evidenced by a great variety of automated platforms existing and available for users in function of their needs. Each platform design offers specific advantages and each has its limitations. Some of the notable challenges that engineers have to face when designing a microfluidic system for a life science application result not only from many different types of biological samples but also from the intrinsic complexity and variability between samples of the same type, even after they had been lysed and mixed with liquid reagents. This is because there exists an intricate interplay between fluid dynamics, the materials used for building the system components that will come into contact with the fluids, the assembly processes, and even the intended detection schemes. There is no “one-size-fits-all” system design for all purposes, sample types, or even biomarker types, but there exists a trend for ever increasing miniaturization of the analytical component of the system in order to perform the relevant reactions, like sample processing, release of a key analyte (e.g. nucleic acid), and/or the detection, faster and in ever decreasing volumes.

In general, the part of an automated microfluidic system that enters in direct contact with the biological sample is confined to a disposable fluidic assembly, such as a fluidic cartridge or a testcard, that are usually preloaded with the required chemical reagents for processing and/or analyzing the specimen and frequently for performing test controls. Many of such systems and fluidic assemblies have been described to date. Those that specialize in detection of nucleic acids primarily come with chemistries adapted for amplification reactions, usually based on polymerase chain reaction (PCR), and optionally integrate associated functionalities like sample processing and nucleic acid purification etc. Naturally, due to their specialization, different systems are programmed to run appropriate pre-set protocols wherein, typically, each sample is processed following a predetermined pathway of processing events with little or no room for variation or adaptation.

As fully automated systems allow little flexibility for protocol adaptations in general, less automated or semi-automated platforms incorporating rapid microfluidic handling combined with bench-top sample-processing possibilities are thus desired, especially in research settings or in small- to mid-size testing laboratories that need to rapidly adapt their protocols to different sample types or changing needs like seasonal epidemics involving new mutants or strains of seasonal pathogens. Such semi-automated systems also find frequent use as prototype or first version products that reach the market. However, due to the constantly progressing miniaturization process for component designs and the resulting therefrom ever growing restrictions on the already scaled-down volumes the nano- or microfluidic chips can accept, there exists a need to strike balance between the liquid amounts a system can accept and what the users operating such system can actually handle and accurately load thereto to avoid test-result inaccuracies caused by human error.

### SUMMARY OF THE INVENTION

To address the above explained needs of providing a rapid microfluidics-based system that: (i) allows a certain degree of adaptability to bench-top protocols, and (ii) can be comfortably handled and loaded by a user with the sample material, a microfluidic assembly is herewith disclosed comprising a micro- or nanofluidic chip for performing an analytical test, a housing for enclosing the chip, and a particularly-designed and functional cover for at least partially covering the chip and the housing, the cover being designed such to encompass an additional liquid directing and capturing space between its walls for guiding the optimal amount of liquid into the chip while capturing the excess liquid that could otherwise lead to leakages and interfere with e.g. proper sealing of the assembly.

In one embodiment, such cover can be created as a monobloc that can be molded or 3D printed to contain minimal structures being the opening (32) and the channel (31) forming the liquid directing and capturing space. In an alternative embodiment, such monobloc can be combined with additional layers made e.g. from flexible materials such as foils. In other embodiments, a cover is a multi-layer cover i.e. manufactured as a composite of at least two layers, which can be made with or without such monobloc included as one of the layers.

In a preferred embodiment, the cover (3) is a multi-layer cover, wherein said liquid directing and capturing space is created between such two or more layers. One of the advantages of providing such multi-layer cover is the ability to easily manufacture such covers with fine-tuned properties, such as the materials of the layers and the characteristics of the created therewithin liquid capturing space, to any type of liquid sample that is to be loaded into the chip in function of its amount, and liquid sample properties such as viscosity, lipid-content, rheological behavior, tendency to create bubbles etc.

Thanks to such cover with additional liquid capturing space provided between the walls and/or layers thereof, the probability of erroneous loading of the nano- or microfluidic chip by an e.g. inexperienced user will be substantially reduced as the additional liquid directing and capturing space will be designed to facilitate entering of the right amount of liquid into the analytical space as patterned in the chip, while at the same time draining the excess liquid into said space. With such designed cover functionality, the microfluidic assembly as disclosed herein will not only have the advantage of reducing the risk of spillages around the chip area, which could interfere with e.g. with efficient sealing of the entry to the chip, but also will provide the additional comfort for the users by allowing them to manipulate easier to handle or control larger volumes of liquid, which otherwise could me more prone to e.g. pipetting error.

In view of the above, it is a first object of the present disclosure to address and overcome certain limitations on flexibility for straightforward adaptation to different protocols and sample types of the currently existing microfluidic assemblies in the domain life sciences.

Then, it is a second object of the present disclosure to provide a fast workflow that allows more flexible sample processing, nucleic acid purification, target amplification and detection protocol-associated functionalities.

And further, it is a third object of the present disclosure to provide an easy to handle and user-friendly disposable microfluidic assembly for a preferably semi-automated mode of running a sample analysis system, which assembly is designed to limit human-caused errors related manipulation of precise yet very small volumes of liquid samples, frequently and possibly of varying rheological properties.

In line with the above, it is a yet another object of the present disclosure to provide a microfluidic assembly that allows accurate dosing of a possibly relatively small volume (likely in microliters) of a sample solution to be further analyzed and/or processed on a microfluidic nano- or micro-chip.

These and other objects will be evident to the skilled person from the provided herein teachings and are met by the different aspects of the disclosure as defined herein and in the appended claims.

In line with the above, according to a first and very general aspect, a microfluidic assembly is provided herein for performing a molecular test, the assembly comprising
a silicon chip (1) for performing the test, the chip patterned to comprise a continuous groove (11) defining a reaction volume V1 for accepting one or more liquids for performing one or more reactions of the test, the chip comprising an inlet port (12) for filling said groove (11) with a liquid;
a base structure (2) for housing the chip (1); and
a cover (3) covering at least the zone of the chip adjacent to the inlet port (12) and at least partially covering the base structure (2);
wherein the fluidic assembly characterised in that
the cover (3) comprises an opening (32) adapted to align with the inlet port (12), and further comprises a channel (31) extending from said opening (32),
wherein the opening (32) defines a capture volume V2, and
wherein the channel (31) defines a retention volume V3, and
wherein the opening (32) and the channel (31) are arranged to accept into one or both of the capture volume V2 and/or the retention volume V3 the liquid that is exceeding the reaction volume V1.

In a particularly advantageous aspect, an embodiment of said microfluidic assembly is provided comprising
a silicon chip (1) for performing the test, the chip patterned to comprise a continuous groove (11) defining a reaction volume V1 for accepting one or more liquids for performing one or more reactions of the test, the chip comprising an inlet port (12) for filling said groove (11) with a liquid;
a base structure (2) for housing the silicon chip; and
a multi-layer cover (3) comprising at least two layers covering at least the zone of the chip adjacent to the inlet port (12) and at least partially covering the base structure (2);
wherein said advantageous embodiment of the fluidic assembly is characterised in that the cover (3) comprises an opening (32) adapted to align with the inlet port (12), and further comprises a channel (31) formed between at least two layers of the cover (3), the channel (31) extending from said opening (32),
wherein the opening (32) defines a capture volume V2, and wherein the channel (31) defines a retention volume V3, and
wherein the opening (32) and the channel (31) are arranged to accept into one or both of the capture volume V2 and/or the retention volume V3 the liquid that is exceeding the reaction volume V1

In a further aspect, uses of the disclosed herein microfluidic assembly are provided for performing a detection test for a presence of an at least one target nucleic acid, preferably wherein the at least one target nucleic acid is derived from a pathogen such as a virus, for example SARS-CoV-2 virus.

In an additional aspect, also described herein is a straight-forward method of assembling the microfluidic assembly according of the disclosure, the method comprising at least the step of covering the base structure (2) housing the silicon chip (1) with the cover (3), advantageously, a multi-layer cover (3), comprising the opening (32) and the channel (31) extending from said opening (32), as described above, such that at least the opening (32) of the cover (3) aligns with the inlet port (12) of the chip (1).

### Definitions

In general, as used herein the terms “fluidic”, “microfluidic” or sometimes “nanofluidic” refers to systems and arrangements dealing with the behavior, control, and manipulation of fluids that are geometrically constrained to millimeter, sub-millimeter/sub-micrometer-scale in at least one or two dimensions (e.g. width and height of a channel or groove). Such small-volume fluids are moved, mixed, separated or otherwise processed at a micro scale requiring small size and low energy consumption. Nanofluidic systems include structures such as micro pneumatic systems (pressure sources, liquid pumps, micro valves, etc.) and nanofluidic structures for the handling of micro, nano- and picoliter volumes (microfluidic grooves, etc.).

As used herein, the terms “microfluidic assembly” and “fluidic assembly” and sometimes “nanofluidic assembly” are to be treated as synonyms and construed as relating to a multi-part component assembled from separately manufactured parts, wherein at least one of the parts can be identified as “microfluidic chip” and wherein said multi-part component is formed as a single object that can be transferred or moved as one fitting inside or outside of a larger instrument adapted to and/or suitable for accepting or connecting to such “microfluidic assembly”.

As used herein, the terms “microfluidic chip”, “fluidic chip”, “nanofluidic chip”, “nanofluidic processor”, or as used mostly herein just “chip”, are to be treated synonymously and in accordance with its standard meaning within the field, construed as referring to a small physical device, the device usually made of silicon frequently monolithic, which houses a patterned fluidic circuit represented as at least one groove “patterned” in the chip's body, the groove being adapted for processing a liquid.

In line with the above, as used herein the term “groove” is to be understood as any functionally defined compartment of any geometrical shape within the chip of the nanofluidic assembly, defined by at least one wall and comprising the means necessary for performing the liquid processing function which is attributed to this compartment, such as e.g. sample processing and/or analysis, e.g. by nucleic acid amplification e.g. by PCR.

As used herein, the “microfluidic assembly” and the compatible therewith instrument can be seen as forming an at least semi-automated system, or an at least semi-automated platform, wherein the term “semi-automated” indicates that at least a part of the protocol as performed on the “microfluidic assembly” was started or performed in a non-automated way by a user at the bench-side, possibly manually. Usually said non-automated part should be understood as a part relates to biological sample preparation, such as liquefaction and/or nucleic acid extraction.

As used herein, the term “sample”, is to be construed broadly as any liquid potentially comprising an analyte of interest, which liquid can be provided into the chip for being processed on said chip. As used herein, the analyte will usually be a target nucleic acid to be detected with the help of the chip being a part of the disclosed herein microfluidic assembly. The sample can be liquid biological sample obtained from an individual, but it can also be a biological sample that was pre-processed on a bench in accordance with any sample processing protocol, for example to liquefy the sample or to perform nucleic acid isolation, in order to be able to provide such pre-processed sample into the chip. Such sample will hopefully contain a detectable nucleic acid, usually being a nucleic acid of a pathogen, e.g. viral DNA or RNA, but may also contain nucleic acid from the person from whom the sample was obtained such as genomic DNA, mitochondrial DNA, mRNA, IRNA, tRNA, microRNA etc.

Also, as used herein the term “nucleic acid isolation” is to be interpreted as any form of releasing nucleic acids from a biological material to make it available for amplification.

As used herein, the term “channel” will usually be construed as elongated space provided in the cover of the disclosed herein microfluidic assembly, unless the context indicates to the contrary. For better discrimination between said channel and the patterned paths of the fluidic circuit formed in the chip, for the latter the term “groove” will usually be used.

As used herein the term “multi-layer cover” is to be construed as a term synonymous to a term “composite cover”, which both terms relate to a specific part of an advantageous embodiment of the disclosed herein microfluidic assembly, which part has a composite structure, i.e. structure of assembled together at least two but likely at least three or more distinct layers.

It is also to be understood that the terminology used herein is for purpose of describing particular embodiments only and is not intended to be limiting. It must be noted that, as used in the specification and the appended claim, the articles “a”, “an”, “the”, and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings do not exclude other elements or steps.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the term “multiple” in “multiple . . . ” or “multiple . . . ” is to be understood as referring to more than one, e.g. a plurality of . . . . In the context of a . . . , the term “multiple” will usually refer to more than 1, such as, 2, 3, 4, 5, 6, 7, 8, 9, 10 or in the range of multiples of 10.

### BRIEF DESCRIPTION OF THE DRAWINGS

For a fuller understanding, reference is made to the following detailed description taken in conjunction with the accompanying drawings in which:

FIG. 1 shows exploded view of an advantageous embodiment of the disclosed herein microfluidic assembly in a form of a testcard, wherein the cover (3) is a multi-layer cover (3). In said embodiment, the opening (32) adapted to align with the inlet port (12) of the microfluidic chip (1) and the channel (31) extending from said opening (32) can be formed within at least one or more of the layers of said multi-layer cover (3);

FIG. 2 shows a schematic embodiment of the microfluidic silicon chip (1) patterned with a meandering groove (11) for performing the assay, which is covered by a glass plate (10), thus defining volume V1 within the groove for performing the assay on the chip. The inlet port (12) for accessing said volume V1 and the outlet port (13) adapted for venting the groove (11) are indicated accordingly;

FIG. 3 shows an example of a base structure (2) in a form of an elongated base plate as showed in the embodiment of the microfluidic assembly in FIG. 1. Additional elements for housing and/or supporting the chip (e.g. 21, 211) and for aligning (51, 52) with the multi-layer cover during the assembly process of such exemplary testcard are indicted;

FIG. 4 shows a zoomed-in view of the top part of the microfluidic assembly embodiment of FIG. 1, with the zone of the multi-layer cover (3) in contact with the chip (1) and the base structure (2). The opening (32) within the cover (3) that is aligned with or encloses the inlet port (12) of the microfluidic chip (1) and defines the capture volume V2 is indicated, together with the channel (31) extending from said opening (32), both of which can be accessed through the enlarged entry window (320) provided as part of the opening for the ease of applying the sample to be analysed onto the chip (1). The outlet port (13) for venting the groove (not shown for clarity) of the chip (1) is also indicated as aligned with the second opening (33) within the cover (3);

FIG. 5 shows a zoomed-in view of the bottom part of the microfluidic assembly embodiment of FIG. 1, with the through-hole in the base structure (2) forming a window (213) through which the chip (1) can be made visible for detection purposes or can be accessed for contacting with a temperature control element of the system for operating the testcard, such as a thermoelectric cooler (TEC) or another Peltier device (not shown);

FIG. 6 shows photography of a part of an assembled prototype of the exemplary embodiment as shown in FIG. 1, in particular indicating the position of the chip (1) within the base structure (2), the multi-layer cover (3) with exemplary indication of some of its functional openings (12, 32, 35), and the channel (31) as formed between the layers of the cover (3).

FIG. 7 shows a photography of the assembled prototype from FIG. 6 with a protective PCR tape serving as an example of the additional capping (4) and an example of a removable liner (36) positioned between said PCR tape and the multi-layer cover (3);

FIG. 8 shows a photography of an exemplary support with guides for performing a simple and guided assembling of the different elements of the exemplary embodiment of the microfluidic assembly of FIG. 1 together, such as the base structure (2—shown) and the cover (not shown) and possibly also the additional capping with or without the liner (not shown) along the metal guides as shown on the photography.

### DETAILED DESCRIPTION OF THE INVENTION

Since automated microfluidic platforms vary greatly in their flexibility for introducing variables into their sample and nucleic acid preparation functionalities, which are the first steps in the majority of the automated nucleic acid-based analytical processes, performing those first steps manually or with the use of existing commercial kits may be helpful in introducing variations into the protocol design. In order to speed up the process of the assays, the remaining steps can be kept in an automated format.

For such automated steps, a microfluidic assembly as disclosed herein can easily be used for a highly adaptable and flexible integration in a semi-automated fluidic workflow. The microfluidic assembly of the disclosure aims to be easy for handling by users and for being loaded at minimized risk of user-made pipetting mistakes associated with small liquid volumes of possibly very variable and up-front manually-prepared fluidic samples. With these advantages, the disclosed herein microfluidic assembly can easily be introduced for performing the automated part of the sample analysis process and is readily combinable with manual bench-top protocols or with commercially available kits used in steps preceding the automated part in the workflow.

Accordingly, in a first aspect, provided herein is a fluidic assembly for performing a molecular test, the assembly comprising:
a silicon chip (1) for performing the test, the chip patterned to comprise a continuous groove (11) defining a reaction volume V1 for accepting one or more liquids for performing one or more reactions of the test, the chip comprising an inlet port (12) for filling said groove (11) with a liquid;
a base structure (2) for housing the chip (1); and
a multi-layer cover (3) comprising at least two layers covering at least the zone of the chip adjacent to the inlet port (12) and at least partially covering the base structure (2);
the fluidic assembly characterised in that
the cover (3) comprises an opening (32) adapted to align with the inlet port (12), and further comprises a channel (31) formed between at least two layers of the cover (3), the channel (31) extending from said opening (32),
wherein the opening (32) formed within the cover (3) defines a capture volume V2, and
wherein the channel (31) formed within the cover (3) defines a retention volume V3, and
wherein the opening (32) and the channel (31) are arranged to accept into one or both of the capture volume V2 and/or the retention volume V3 the liquid that is exceeding the reaction volume V1 and that is fed into the inlet port (12) of the chip (1).

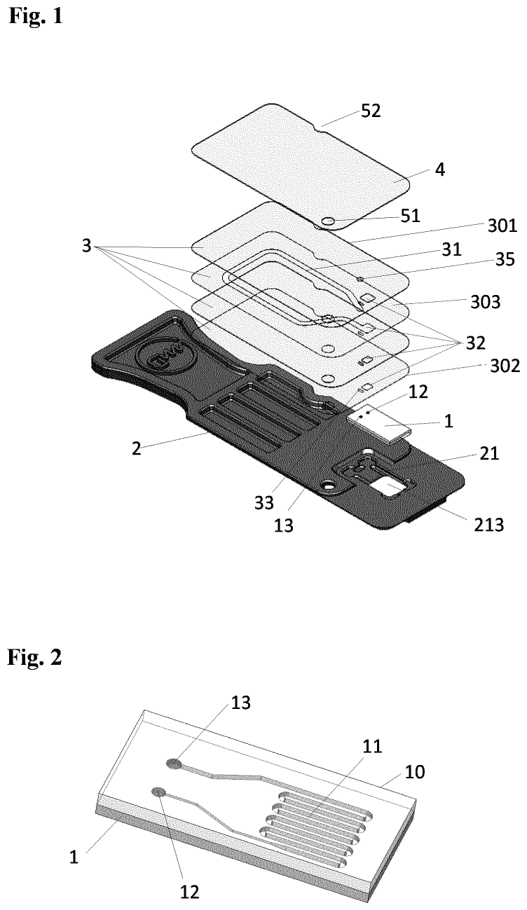

An exemplary embodiment of such assembly is shown in FIG. 1 in an exploded view, wherein the assembly comprises a transparent multi-layer cover (3) and monolithic silicon chip (1) for performing the test of interest. Such exemplary chip (1) is schematically shown in FIG. 2, showing a meandering continuous groove (11) patterned within the silicon chip body and defining a reaction volume V1 together with a glass plate (10) overlaying the chip body. As it will be appreciated by those skilled in the art, any type of microfluidic chip compatible with the general concept of the disclosed herein fluidic assembly may be used, including chips wherein the groove (11) is covered by a different material such as any polymer, plastic, metal, material or even tape, possibly transparent tape.

The reaction volume V1 is the volume adapted for accepting one or more liquids, such as the sample liquid, wash buffers, and various reagents for performing one or more reactions of the test. The chip (1) comprises an inlet port (12) for filling the groove (11) with the liquids, which groove (11) is schematically visible in FIG. 2 from underneath the transparent glass plate (10), and may further comprise a similarly made outlet port (13) for venting purposes.

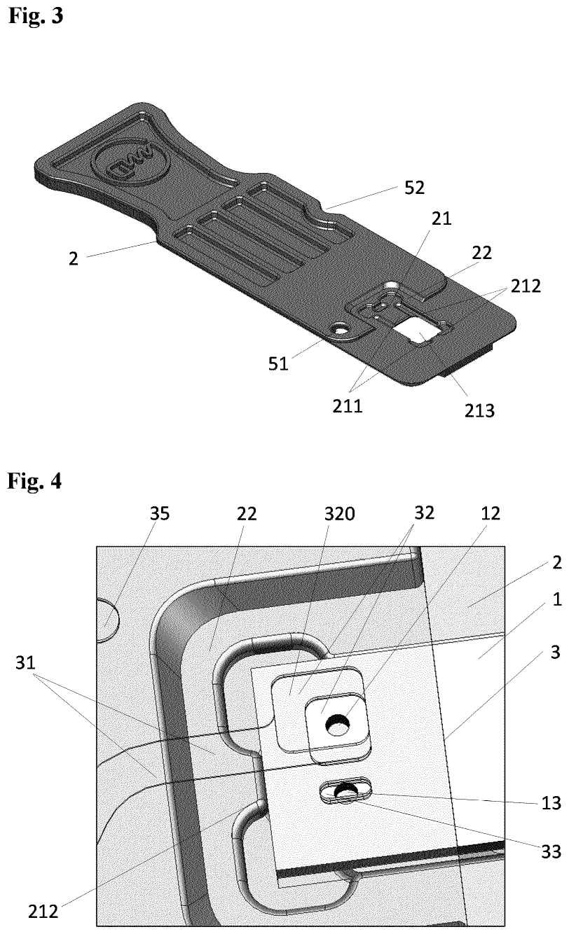

As can be seen in FIG. 1, the fluidic assembly comprises a base structure (2) for housing the silicon chip, in this embodiment shown as a baseplate also represented in isolation in FIG. 3. The assembly will advantageously be disposable and hence the base structure can be made from a thermoplastic material; for example from polycarbonate, like black (medical grade) polycarbonate. Black, generally dark, or even opaque, and/or generally non-reflective materials have the advantage of reducing reflection when light-based detection is considered, and consequently may be preferred in certain embodiments of the microfluidic assemblies as disclosed herein and systems compatible therewith. Similarly, in case the disclosed microfluidic assembly will have to withstand thermocycling, not only the base structure (2) but also other components in general will advantageously be made of materials that resist high temperatures, e.g. being temperatures above 90° C. and/or around 100° C.

As seen in greater detail in the schematic representation in FIG. 3, the exemplary embodiment of the base structure (2) may comprise additional optional 3D structures such as an asymmetric part for preventing upside-down handling of the microfluidic assembly when positioning into the automated system compatible therewith and for interacting with such system like an elongated “bumper” symbolically shown along one of the rims of the testcard. Advantageously, further structures for housing reagents and/or buffers may also be present, in addition to specific structures for supporting the chip (1), which will be discussed in more detail further. Other standard and/or useful features as known in the art, like barcodes, handles, and/or springs with their appropriate location for interfacing a given reader type as included in the system, may naturally also be included in different embodiments of the base structure (2), which will be apparent to those skilled in the art and consequently will not be discussed in further detain in this section.

A unique functional element of the advantageous embodiment of the disclosed herein microfluidic assembly is the multi-layer or composite cover (3) comprising at least two, preferably more layers (301, 302, 303) that are positioned such to cover at least the zone of the chip (1) adjacent to the inlet port (13) of the chip (1) and at least partially cover the base structure (2) in the chip's vicinity. The zone where these parts of the microfluidic assembly meet is shown in greater detail in FIG. 4. As can be seen therefrom, the cover (3) comprises an opening (32) adapted to enclose or align, preferably concentrically or nearly concentrically, with the inlet port (12) of the chip (1), and further comprises a channel (31) extending from said opening (32) and formed between at least two layers of the cover (3). The channel (31) can advantageously be seen in case all or appropriate layers of the cover (3) are made from transparent materials. In alternative possible embodiments, the cover (3) can be manufactured as a monobloc using a technique such as moulding or 3D printing, or any other technique as known in the art.

The opening (32) defines a liquid capture volume V2, whereas the channel (31) defines a retention volume V3. Both the opening (32) and the channel (31) are arranged to accept into one or both of the capture volume V2 and/or the retention volume V3 the sample liquid as applicable by the user to the assembly, which sample liquid is exceeding the reaction volume V1 as acceptable within the groove (11) of the chip (1).

The fluidic assembly structure is arranged to accept one or more, preferably aqueous, liquids. An example of one of those liquids may be a pre-processed sample and may contain a nucleic acid extract prepared from a biological sample. Such extract may be prepared manually according to any one of possible variations in the nucleic acid extraction protocol as required by the given test design, e.g. by boiling, chemical lysis, mechanical disruption, liquefaction, etc., or with the help of commercially available kits. The liquid may further contain all the reagents required to detect specific nucleic acid targets that may be present in such already processed biological sample. Such reagents may be added to the liquid according to any one of the possible or preferred variations in a given extraction protocol as designed for a given test protocol. The nucleic acid in the liquid may then be directly analyzed using the disclosed herein microfluidic assembly. In case of small expected amounts of a given nucleic acid target, a nucleic acid amplification step may be required and all or part of the reagents necessary may be contained in the liquid applicable to the assembly by the user or can be provided in the assembly. The reagents in such liquid for performing the detection by amplification are often referred to as master mix. Although PCR and RT-PCR are arguably to most-known exemplary nucleic acid amplification methods in the field, alternative methods such as LAMP, NASBA, etc. may also be used in different embodiments of the microfluidic assembly and automated processing compatible systems as compatible therewith.

The fluidic assembly may accept one or more liquids. The silicon chip (1) which is the part of the fluidic assembly that performs the test comprises for that purpose at least one continuous groove (11) defining a reaction volume V1 for accepting the one or more liquids for performing one or more reactions of the test. The chip comprises an inlet port (12) for filling said groove with the one or more liquids and at least the zone of the chip adjacent to the inlet port is covered with the cover (3), preferably being a multi-layer cover comprising at least two, preferably more layers. The liquid brought to the inlet port (12) of the chip will be drawn into the groove (11), e.g. via capillary forces and/or use of externally applied pressure or negative pressure, depending on the design. The groove (11) may be a straight channel, or preferably will contain multiple bends for expansion and creation of a larger reaction volume V1. Bends with rounded edges are preferred as they minimize the phenomenon of bubble formation when passing through the groove (11). Consequently, provision of grooves formed as meanders or alternative curved forms like circular, spiral or looped shaped paths or combinations thereof are preferred for allowing minimally perturbed continuity of fluid passage within such patterned fluid circuit.

Manual bench-top sample processing protocols and commercially available kits having the same purpose usually result in a processed sample suspended in a liquid volume much larger than the amounts that can be accepted and therefore should be transferred into a micro- or nanofluidic chip for rapid automated sample processing in an automated microfluidic system. Naturally, manual transfer of an accurate amount of exactly 1 μl-2 μl (or even smaller) or a frequently viscous sample solution into an entry of a microfluidic chip may be tricky even for manually-skilled and experienced laboratory technicians. Consequently, this step is prone to human error and can have an impact on the accuracy of the final readout the automated system will ultimately generate. This is particularly true when precise amounts are required to be manually transferred by a user to correctly fill V1 of e.g. about 2 μl or smaller. Introduction of generally around 2-2.5 μl or less (although, for some more difficult liquids possibly even 5 μl or even more) of liquid, especially viscous or sticky ones to the inlet port of the chip in the fluidic assembly with a transfer pipette will inevitably be subject to volume variance and may introduce volumetric errors to the liquid drawn into the chip's groove.

The volumetric error may be amplified as a consequence of bad pipette calibration. Further, the little amount of liquid may splash outside the inlet port when pushing the liquid out of the pipette tip, thus even further affecting the volume variance as reaching the inlet port (12) leading into the space as defined within the one or more groove of the chip for performing automated reactions.

Consequently, provision of the additional capture volume V2 and the retention volume V3 as defined in the cover of the disclosed herein assembly comes with the advantage of allowing the user to acquire and manipulate larger, i.e. easier to pipette and transfer and with lesser risk of negative volumetric error, volumes of the sample liquid to ultimately load onto the microfluidic assembly as provided herein.

In other words, the advantage of the provided herein assembly is that a user will be able to load the microfluidic assembly as described herein by performing a method comprising a step of providing, possibly via pipetting, an easy to manipulate input volume Vi of liquid to be transferred to the entry port (12) of the chip, wherein said input volume Vi is at least equal to or larger than the reaction volume V1 and preferably is smaller than or equal to the sum of the reaction volume V1 defined by the chip, and both the capture volume V2 with the retention volume V3 as defined within the cover (3) of the disclosed herein assembly. This can be expressed by the following equation: Vi<=V1+V2+V3

In other words, when loading the microfluidic assembly as disclosed herein, the user will confidently be able to acquire and transfer an easier to manipulate volume Vi exceeding the reaction volume V1 as defined by the microfluidic chip, wherein the excess liquid as acquired by the user and exceeding the reaction volume V1 will safely be captured into the capture volume V2 and/or the retention volume V3 as defined within the cover (3) of the disclosed herein microfluidic assembly. Simply put, it is easier to pipette e.g. 4 μl of a sample liquid and be sure that the e.g. 2 μl of the reaction volume as required by the dimensions of the groove (11) of the chip (1) will be perfectly filled in, while the excess liquid is safely drained into the additional space as provided within the cover (3), and without missing e.g. 0.2 μl when trying to pipette the exact amount of 2 μl and suffering such exemplary one tenth volumetric error due to e.g. liquid viscosity issues or faulty pipette calibration.

In view of the above, in a possible embodiment, a microfluidic assembly is disclosed herein, wherein any one of the volumes V1, V2, and V3 is provided within a range of 0.05 μl-10 μl, preferably 0.1 μl-5 μl, preferably 0.5 μl-3 μl, most preferably 1 μl-2.5 μl. Other of the volume values however can also easily be imagined based on different assay or desired analyte types, and depending on the application and designed workflow as dictated by a given experiment or test to be performed with the help the disclosed herein microfluidic assembly.

In a further and related embodiment, a microfluidic assembly is advantageously provided, wherein the sum of the capture volume V2 and the retention volume V3, further referred to as V2+V3, is equal to or larger than at least a half of the reaction volume V1 in accordance with the equation V2+V3≥½ V1, and preferably wherein it is equal to or larger than at least the reaction volume in accordance with the equation V2+V3≥V1.

In further, possibly advantageous embodiments even greater volume differences can be envisages such as e.g. V2+V3 ≥1½ V1 or 2 V1 or even greater, depending e.g. on the attained miniaturisation level of the reaction volume V1 as provided by the chip, or on the particularly difficult to handle sample properties.

The great advantage of providing the additional liquid directing and capturing space as created between the layers of the cover (3) being a composite cover (3), is the enormous ease of manufacturing great many variations of such composite layers (3) having differing or fine-tuned properties that would be compatible and attachable to one or just a few models of the base structure (2).

Such differing multi-layer cover properties can be of many types and result from e.g. different materials chosen in function of different reagent types or sample types, materials with different liquid absorption or affinity properties, varying cover (3) thickness and rigidity as defined by the number of the layers of the composite or the layer types, different total volumes V2+V3 and/or ratios between V2 and V3, additional spaces and substructures for capturing the excess liquid, or even alternative additional tests or control tests like colorimetric, contamination, or pH tests positioned within the channel (31) etc., additional access points to reach the contents of the channel (31). Possible further options even include introduction of localized weakness zones possibly combinable with sealable zones allowing removal of a part of such composite structure or its one or more layers together with an excess sample liquid as captured therein, for possible recovery purposes for re-running the assay in case of a failed control or even for freezing and/or sending the excess sample liquid as captured between the cover layers to another laboratory for a follow-up analysis by another technique.

Layers of such composite covers (2) can be made of easily accessible materials including various types foils and/or tapes, such as one- or two-sided tapes. Following creation of the appropriate structures in the appropriate layers such as at least the opening (32) and the channel (31), different layers of the composite cover (2) made from such commercially accessible materials, can then be attached together by heat-sealing, lamination, or application of different adhesives or sealants like glue, or thanks to the sticking properties of the one- or double-sided tape of choice.

In line with the above, in a possible embodiment a microfluidic assembly is provided, wherein the one or more layers of the cover (3) comprises or consists of foil or tape, preferably being double-sided tape. Examples of suitable materials can be obtained from Adhesives Research, 3M, Raleigh Coatings, or Thorlabs, to name just a few.

Many of such materials are available with unique properties such as different hydrophilicity or hydrophobicity characteristics available on one or both sides. Such materials can easily be assembled in such a way that the final composite layer (3) will display desirable liquid absorption or affinity behavior towards different liquid or sample types, which can be used when designing such composite cover (3) for the microfluidic assembly of the disclosure in view of a particular test protocol to be performed with it.

Hence, in a yet another embodiment, a microfluidic assembly is provided, wherein at least one, preferably more, of the layers of the cover (3) comprise a hydrophilic side and wherein said side is arranged such to enhance absorption of the liquid into the channel (31).

In the context of additional structure as included in such layers, in a likely embodiment, a microfluidic assembly of the disclosure is provided, wherein the cover (3) comprises, possibly in at least one of its layers, a further channel opening (35) extending from and in fluid communication with the channel (31), wherein the further channel opening (35) is possibly and preferentially adapted for venting the channel (31). In such case, the further channel opening (35) is preferentially provided at the opposite end of the channel (31) with respect to the opening (32) adapted to align with the inlet port (12) of the chip (1). An embodiment of the microfluidic assembly with such positioned further channel opening (35) for venting can be seen from a photography of a possible embodiment of the disclosed herein assembly shown in FIG. 6.

In a particularly advantageous embodiment, for example as already shown in the exploded view in FIG. 1, a microfluidic assembly of the disclosure can be provided, wherein the cover (3) comprises at least three or more layers comprising two outer layers (301, 302) and at least one or more inner layers, wherein at least one of said inner layers (303) comprises a through-hole defining the shape of the channel (31).

In a possible further embodiment of such embodiment, a microfluidic assembly can be provided wherein at least one of the two outer layers (301, 302) comprises the already above-described further channel opening (35) extending from and preferably adapted for venting the channel (31). For example, in FIG. 1 such venting further channel opening (35) is indicated in outer layer 301, which has the advantage of being sealable after the venting action has been performed e.g. a PCR tape providing an optional additional capping (4) that can provide in such instance an additional securing means for the filled contents of the channel (31), thus preventing potential spillages etc.

As already discussed in the context of the chip (1) example as shown in FIG. 2, in an advantageous embodiment, the chip (1) will also comprise an opening for venting. Thus, in a further advantageous embodiment, a microfluidic assembly is provided, wherein the chip (1) further comprises an outlet port (13) adapted for venting the groove (11) while filling the groove (11) with the liquid; preferably wherein the cover (3) is further covering at least the zone of the chip adjacent to the outlet port (13) and most preferably wherein the cover (3) further comprises a second opening (33) arranged to be aligned with the outlet port (13) for the purpose of easy venting of the chip (1) after the application of the cover. Such second opening (33) of the cover (3) as aligned with the outlet port (13) of the chip (1) is clearly represented in the schematic illustration in FIG. 4.

For potential spillage prevention or control during transport and handling of an already loaded with a sample liquid microfluidic assembly of the disclosure, an additional capping element (4), or, simply, the additional capping (4), can be included as shown in FIG. 1 for at least closing or sealing the opening (32).

In an advantageous embodiment, the capping (4) may be made from a material that counteracts leakage, evaporation, and/or vapor transport or transfer during thermocycling, for example a PCR-suitable tape (as used herein, sometimes referred to as “PCR-tape”). Advantageously, the additional capping will be transparent, which is convenient for the visual assessment of the extent of filling of the channel (31) while loading the disclosed microfluidic assembly with a sample liquid.

Hence, in a further advantageous embodiment a microfluidic assembly is provided further comprising an additional capping (4), such as a tape, possibly PCR-tape, for sealing the opening (32) and/or inlet port (12) and possibly also the second opening (33) and/or outlet port (13) and/or the further channel opening (35) of the cover (3), if present.

In a further advantageous embodiment, the additional capping (4), preferably being a PCR-tape, is premounted on the microfluidic assembly as disclosed herein. In this embodiment, following the loading of the groove (11) of the chip (1), the user can easily apply the additional sealing by said additional capping (4), for example by applying pressure to glue it to at least the relevant parts of the cover (3), or by e.g. removing a liner separating such additional capping (4) from the relevant parts of the cover (3).

In a further embodiment, a microfluidic assembly of the disclosure is provided, comprising such removable liner (36) for at least partially protecting the cover (3) at least over the part of the cover (3) comprising the opening (32) adapted to align with the inlet port (12) of the chip (1). Such removable liner (36) can be made from any suitable material as known in the art, like e.g. paper, or plastic, and provides on its own an additional advantage of protecting the relevant openings and entry points of the disclosed microfluidic assembly from mechanical damage, and/or contamination and/or dirt like dust but it is particularly advantageous when provided in combination with the additional capping (4), preferably a premounted one as described above.

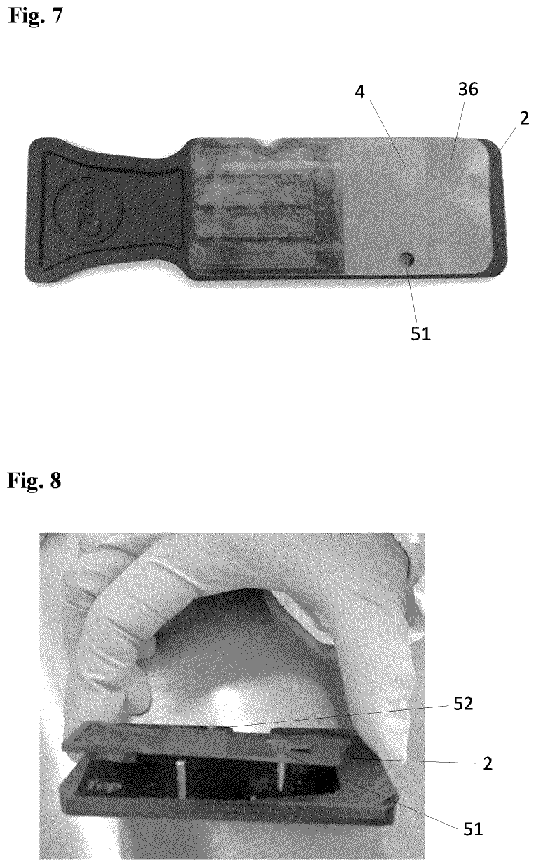

Hence, in a related preferably embodiment, a microfluidic assembly is provided wherein at least a part of the liner (36) is positioned between the part of the cover (3) comprising the opening (32) adapted to align with the inlet port (12) of the chip (1), and the additional capping (4). Such a premounted removable liner (36) is shown in FIG. 7 containing a photograph of a prototype of a possible embodiment of the disclosed herein microfluidic assembly, wherein a part of a premounted additional capping (4) is separated by the liner (36) from the part of the cover (3) wherein the relevant ports like the inlet port (12) of the chip and the venting port of the chip (13) or the venting port of channel (35) are positioned. In an exemplary embodiment, upon lifting such liner (36), these openings become accessible for the user, while upon its removal, the exposed part of the premounted PCR-tape provided as the additional capping (4) can be sealed.

For a further facilitation of the loading of the sample liquid into the chip (1), an embodiment of the microfluidic assembly of the disclosure can be provided, wherein the opening (32) within the cover (3) further comprises an enlarged entry window (320) for easier accessing the inlet port (12) of the chip (1), the entry window (320) being wider in at least one dimension, preferably being in both lengths and width, with respect to the bottom part of the opening (32) that are positioned closer to the inlet port (12). An embodiment of such enlarged entry window (320) is shown in FIG. 4. A mode of including such enlarged entry window (320) in one or more of the layers of the composite cover (3) is shown in FIG. 1. In the latter exemplary embodiment, the enlarged entry window (320) is manufactured in two layers, being the external layer (301) and the at least one inner layer (303) with the channel (31), wherein a part of the enlarged entry window (320) in this case is an integral part of the channel (31) in the channel defining layer (303). Naturally, many other possible embodiments of providing such enlarged entry window (320) for facilitated sample loading can be envisaged.

As already explained, the herein disclosed fluidic assembly is characterized in that the cover (3) comprises an opening (32) adapted to align with the inlet port (12), and further comprises a channel (31) formed between at least two layers of the cover (3), the channel (31) extending from said opening (32). Depending on the design of the base structure, the at least of part of the channel (31) can be included in lowest layer (302) of the composite cover (3), i.e. being the layer (302) abutting the base structure (2), and/or in any one or more of the inner layers (303). For the opening (32) adapted to align with the inlet port (12), in an embodiment that is attractive from the point of view of spillage-prevention and efficient attachment considerations to the base structure (2), a microfluidic assembly can be provided wherein at least the lowest part of the opening (32) is arranged such as to enclose or at least partially enclose the inlet port (12), possibly by being aligned concentrically or nearly concentrically with the inlet port (12) wherein at least said lowest part of said opening (32) is positioned in the lowest layer (302) of the composite cover (3), as it is shown in FIG. 1.

As already mentioned earlier, the base structure (2) of the disclosed microfluidic assembly can also comprise additional elements that will ensure stable and leakage-proof positioning of the chip (1) versus the cover (3). In a possible embodiment, a microfluidic assembly can preferably be provided, wherein the base structure (2) comprises an indented pocket (21) for accommodating and/or containing the chip (1), thus ensuring the latter's fixed positioning within the base structure (2), advantageously further providing compatible sub-structures such as e.g. appropriately positioned recesses or a cut-corner marking to avoid misalignments and ensure that the chip (1) is inserted into the pocket (21) of the base structure (2) in the correct way.

Preferably, in a related embodiment, a microfluidic assembly is provided wherein the pocket (21) has a depth adapted such that the surface of the chip (1) facing the cover (3) is levelled with a part of the base structure (2) that contacts the cover (3), which features is advantageous for correct and leakage-tight spreading of the cover (3) over even-levelled chip (1) and the base (2). However, especially with intentionally disposable components, frequently involving thermoplastic or other plastic materials which production not always focused on highest precision, certain degree of final product variability should always be taken into account. Consequently, for possibly accommodating for the difference of height between chip (1) and the part of the base structure (2) when the cover (3) is placed, in a yet another advantageous embodiment, the pocket (21) can be provided with a relief area (22) as shown in FIGS. 3 and 4, for even spreading of the cover (3) over the relevant chip's (1) surface and the adjacent thereto respective surface of the base structure (2).

For even better alignment, additional modifications can be foreseen; for example, in a further possible embodiment, the indented pocket (21) can be provided comprising an elevated zone (211) and/or additional elements such as pins (212) for further positioning and/or supporting the chip (1).

In addition to the above, in an exemplary prototype of an embodiment of the disclosed fluidic assembly as shown in a photograph in FIG. 6, wherein a further advantageous feature relates to part of the chip (1) being exposed and not covered by the cover (3). Depending on how the chip is positioned and which of its sides is facing the base structure (2), this exposed part can in certain embodiments be exposed one or more of detection modules, such as a charge-coupled device (CCD) camera, or to thermocycling modules, such as thermoelectric cooler (TEC), the automated system adapted to accept and operate the microfluidic assembly of the disclosure. For example, to help contacting with the TEC, in the base structure (2) there can be a part provided next to the chip (1) having lower height compared to the top of the chip (called front reveal), but many other additional structures for contact making can be designed and included by the skilled person.

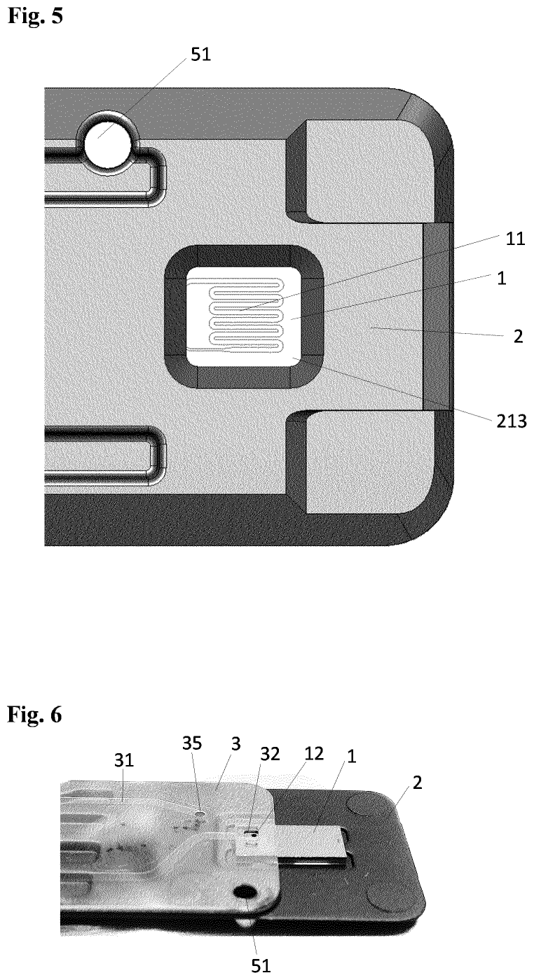

In a further possible embodiment of the disclosed microfluidic assembly, the base structure (2) can be provided with a through-hole forming a window (213), preferably positioned at least partially within the indented pocket (21) for making at least a part of the chip (1) visible for detection modules and/or accessible to elements, such as Peltier/thermoelectric cooling (TEC) modules, of the automated system for operating the microfluidic assembly, from the side of the base structure (2) opposite to the side on which the cover (3) is positioned. Such window can be seen in FIGS. 1, 3, and especially 5, wherein in the latter case, a bottom view of the chip (1) with the visible groove (11) through such window is displayed. In an advantageous further embodiment, the inner walls or edges of the window can be tapered as shown in FIG. 5 to help tilted light to enter more easily or to help tilted reflected light to leave the chip.

In an further embodiment, for greater ease of manufacturing, the microfluidic assembly as disclosed herein can further be provided, wherein the base structure (2) and the cover (3), and possibly also the additional capping (4), and or even the liner (26), comprise at least one, preferably two or more, alignment guiding elements (51, 52), such as pin-holes (51) and/or detents (52), as shown e.g. in FIGS. 1, 5, 6, and 7, for performing a straight-forward assembling of the different elements of the microfluidic assembly of the disclosure, along metal guides provided as part of an e.g. support plate or a support station as shown on the photography of FIG. 8

In another aspect, although possibly and preferably related to the above-described embodiment, further provided is a method of assembling the microfluidic assembly according to any one of described embodiments, the method comprising at least the step of covering the base structure (2) that houses the chip (1) with the cover (3) comprising the opening (32) and the channel (31) extending from said opening (32), such that at least the opening (32) of the cover (3) aligns with the inlet port (12).

As described above, the cover (3) can be an appropriately 3D printed or moulded monobloc with or without additional layers or, preferably can be a multi-layer cover wherein the liquid directing and capturing space including the opening (32) and the channel (31) is created between or by at least two, preferably more layers of the cover (3). When covering the base structure (2), different layers of such multi-layer cover can be provided as already assembled or glued, or can be added sequentially i.e. one-by-one. Alternatively, some layers can be added as separate single-layers that will be attached to the base structure (2) and/or other layers during the assembly process, e.g. using adhesive sides of the tape, and/or can be added as an already pre-laminated multi-layer substructure of such final multi-layer cover (3). Different modes of assembling such multi-layer covers are naturally possible and can easily be envisaged by skilled persons, and consequently, will not be covered herein in further detail.

In preferred embodiments, the method may further comprise an attaching step of premounting of the additional capping (4), like the transparent PCR tape, with or without the included liner (36). Possibly, in further advantageous embodiments, the disclosed herein methods can be performed on a support plate or a support station as shown in FIG. 8, advantageously using guides and various alignment guiding elements (e.g. 51, 52) that may be included in different components of possible embodiments of the disclosed herein microfluidic assemblies.

Lastly, provided herein are use of the microfluidic assembly of the disclosure for performing molecular testing, possibly a detection test for a presence of an at least one target nucleic acid, preferably wherein the at least one target nucleic acid is derived from a pathogen such as a virus, for example SARS-CoV-2 virus.

1-15. (canceled)

16. A microfluidic assembly for performing a diagnostic test, the assembly comprising:
a silicon chip for performing the test, the chip patterned to comprise a continuous groove defining a reaction volume V1 for accepting one or more liquids for performing one or more reactions of the test, the chip comprising an inlet port for filling said groove with a liquid;
a base structure for housing the chip; and
a cover covering at least the zone of the chip adjacent to the inlet port and at least partially covering the base structure;
wherein the cover comprises an opening adapted to align with the inlet port, and further comprises a channel extending from said opening, wherein the opening defines a capture volume V2, and wherein the channel defines a retention volume V3, and
wherein the opening and the channel are arranged to accept into one or both of the capture volume V2 and/or the retention volume V3 the liquid that is exceeding the reaction volume V1.

17. Microfluidic assembly according to claim 16, wherein the cover is a multi-layer cover comprising at least two layers covering at least the zone of the chip adjacent to the inlet port, and wherein the a channel is formed between at least two layers of said multi-layer cover.

18. Microfluidic assembly according to claim 16, wherein the sum of the capture volume V2 and the retention volume V3 is V2+V3, V2+V3 being equal to or larger than at least a half of the reaction volume V1 in accordance with the equation
$$V 2 + V 3 \geq 1 / 2 V 1.$$

19. Microfluidic assembly according to claim 16, wherein the sum of the capture volume V2 and the retention volume V3 is V2+V3, wherein V2+V3 is equal to or larger than at least the reaction volume in accordance with the equation
$$V 2 + V 3 \geq V 1 .$$

20. Microfluidic assembly according to claim 16, wherein the cover comprises a hydrophilic side and wherein said side is arranged such to enhance absorption of the liquid into the channel.

21. Microfluidic assembly according to claim 16, wherein at least one or more of the layers of the cover comprises a hydrophilic side and wherein said side is arranged such to enhance absorption of the liquid into the channel.

22. Microfluidic assembly according to claim 16, wherein the cover comprises at least three layers comprising two outer layers and at least one or more inner layers, wherein at least one of said inner layers comprises a through-hole defining the shape of the channel.

23. Microfluidic assembly according to claim 22, wherein at least one of the two outer layers comprises a further channel opening extending from and adapted for venting the channel.

24. Microfluidic assembly according to claim 16, wherein the chip further comprises an outlet port adapted for venting the groove during filling the groove with the liquid.

25. Microfluidic assembly according to claim 24, wherein the cover is covering at least the zone of the chip adjacent to the outlet port.

26. Microfluidic assembly according to claim 24, wherein the cover further comprises a second opening arranged to be aligned with the outlet port.

27. Microfluidic assembly according to claim 16, wherein at least a part of the cover comprises foil or tape.

28. Microfluidic assembly according to claim 16, wherein at least one or more layers of the cover comprises foil or tape.

29. Microfluidic assembly according to claim 16, the assembly further comprising an additional capping for sealing the opening and/or the inlet port.

30. Microfluidic assembly according to claim 29, wherein the additional capping seals the second opening and/or outlet port, and/or the further channel opening of the cover.

31. Microfluidic assembly according to claim 16, wherein the opening further comprises an enlarged entry window for accessing the inlet port, the enlarged entry window being wider in at least one dimension with respect to the bottom part of the opening.

32. Microfluidic assembly according to claim 16, wherein the base structure comprises an indented pocket for accommodating and/or containing the chip.

33. Microfluidic assembly according to claim 32, wherein the indented pocket has a depth adapted such that the surface of the chip facing the cover is levelled with a part of the base structure that contacts the cover.

34. Microfluidic assembly according to claim 32, wherein the indented pocket is provided with a relief area for accommodating or correcting for the difference of height between chip and the part of the base structure when the cover is placed.

35. Microfluidic assembly according to claim 32, wherein the indented pocket comprises an elevated zone and/or pins for positioning and/or supporting the chip.

36. Microfluidic assembly according to claim 16, wherein the base structure comprises a through-hole forming a window, positioned at least partially within an indented pocket for accommodating and/or containing the chip, the window making at least a part of the chip visible from the side of the base structure opposite to the side on which the cover is positioned.

37. Microfluidic assembly according to claim 16, wherein the base structure and the cover comprise at least one alignment guiding elements.

38. Microfluidic assembly according to claim 37, wherein the alignment guiding elements include pin holes and/or detents.

39. Microfluidic assembly according to claim 16, wherein any one of the volumes V1, V2, and V3 is provided within a range of 0.05 μl-10 μl.

40. Microfluidic assembly according to claim 16, comprising a removable liner, the liner at least partially protecting the cover at least over its part comprising the opening adapted to align with the inlet port of the chip, wherein at least a part of the liner is positioned between said part of the cover and the additional capping.

41. Method of assembling the microfluidic assembly of claim 16, the method comprising at least the step of covering the base structure housing the silicon chip with the cover comprising the opening and the channel extending from said opening, such that at least the opening of the cover aligns with the inlet port of the chip.
